(19) United States
(12) Patent Application Publication
(10) Pub. No.: US 2020/0041848 A1
(43) Pub. Date: Feb. 6, 2020

(54) LIQUID CRYSTAL DEVICE AND METHOD OF MANUFACTURE THEREFOR

(71) Applicant: JSR CORPORATION, TOKYO (JP)

(72) Inventors: Yuusuke INOUE, MINATO-KU, TOKYO (JP); Koji KASHISHITA, MINATO-KU, TOKYO (JP); Ryuuzou OONO, MINATO-KU, TOKYO (JP); Takahito KATOU, MINATO-KU, TOKYO (JP); Koichi MIYACHI, MINATO-KU, TOKYO (JP)

(73) Assignee: JSR CORPORATION, TOKYO (JP)

(21) Appl. No.: 16/338,991

(22) PCT Filed: Sep. 28, 2017
(86) PCT No.: PCT/JP2017/035354

§ 371 Date: Apr. 2, 2019

(30) Foreign Application Priority Data
Oct. 4, 2016 (JP) 2016-196724

(51) Int. Cl. G02F 1/1337; G02F 1/1339; G02F 1/137; G02F 1/1341

(52) U.S. Cl. CPC G02F 1/133711; G02F 1/13394; G02F 1/137; G02F 1/1341; G02F 1/133719; G02F 1/133514; G02F 2001/13712; G02F 2001/13775; G02F 2001/13415; G02F 2001/13396; G02F 1/133723

(57) ABSTRACT

A liquid crystal device 10 includes: a pair of substrates including a first substrate 11 and a second substrate 12 arranged to face each other; and a liquid crystal layer 14 that is arranged between the first substrate 11 and the second substrate 12. This liquid crystal device 10 is configured such that, among the first substrate 11 and the second substrate 12, a liquid crystal alignment film 13 is formed on the liquid crystal layer 14-side surface of the first substrate 11, but no liquid crystal alignment film is formed on the liquid crystal layer 14-side surface of the second substrate 12.

### CROSS REFERENCE TO RELATED APPLICATIONS

This application claims the priority benefit of Japan application serial no. 2016-196724, filed on Oct. 4, 2016. The entirety of the above-mentioned patent application is hereby incorporated by reference herein and made a part of this specification.

### TECHNICAL FIELD

The present disclosure relates to a liquid crystal device and a method of manufacture of therefor.

### BACKGROUND ART

As liquid crystal devices, various liquid crystal devices such as vertical alignment (VA)-type liquid crystal devices in a vertical (homeotropic) alignment mode using a nematic liquid crystal with negative dielectric anisotropy in addition to a horizontal alignment mode type using a nematic liquid crystal with positive dielectric anisotropy, representative examples of which include a twisted nematic (TN) type and a super twisted nematic (STN) type are known. These liquid crystal devices typically include liquid crystal alignment films with a function of causing liquid crystal molecules to be aligned in a specific direction. As materials that form the liquid crystal alignment films, a polyamic acid, polyimide, polyamic acid ester, polyamide, polyester, polyorganosiloxane, and the like are known, and a liquid crystal alignment film made of a polyamic acid or polyimide has preferably been used for a long time due to excellent heat resistance, mechanical strength, affinity with liquid crystal molecules, and the like.

Also, a polymer sustained alignment (PSA) scheme is known as one of alignment processing schemes (see Patent Literature 1, for example). The PSA scheme is a technology for controlling an initial alignment of liquid crystal by mixing a photopolymerizable monomer into a liquid crystal layer provided in a gap between a pair of substrates in advance, irradiating the photopolymerizable monomer with ultraviolet rays in a state in which a voltage is applied between the substrates to polymerize the photopolymerizable monomer, thereby causing pretilt angle properties to be exhibited. According to this technology, it is possible to enlarge a field of view angle, to increase a speed of liquid crystal molecule response, and to solve problems such as insufficient transmittance and contrast which are inevitable in a multi-domain vertical alignment (MVA)-type panel. Also, in recent years, controlling of an initial alignment of liquid crystal by adding a polymerizable compound to a liquid crystal alignment film and irradiating a liquid crystal cell with ultraviolet rays in a state in which a voltage is applied between substrates has also been performed (see Non-Patent Literature 1, for example).

In recent years, not providing a liquid crystal alignment film on a surface of each substrate in a pair of substrates in a liquid crystal device of the PSA scheme has been proposed (see Patent Literature 2, for example). Patent Literature 2 discloses a liquid crystal device of the PSA scheme with no liquid crystal alignment film provided therein, in which two or more types of polymerizable monomer are mixed into a liquid crystal composition and at least one of them is a monomer with a structure that generates ketyl radicals due to a hydrogen abstraction reaction using light irradiation. In this manner, a liquid crystal display device with hardly any display failures and a decrease in a voltage retention ratio is obtained.

Also, development of liquid crystal panels with complicated shapes such as a curved surface display with a bent display surface has advanced with an increase in applications of liquid crystal panels in recent years. A curved surface display is typically produced by attaching a pair of substrates such that a state in which a liquid crystal layer is arranged between the substrates is obtained, thereby creating a liquid crystal cell, and then bending the liquid crystal cell. However, if the liquid crystal cell is bent in order to produce a curved surface display, a region in which deviation in pretilt angles occurs between one substrate and the other substrate of the pair of substrates due to external stress applied in the left-right direction of the substrate may occur. In this case, there is a concern that this may lead to degradation of image quality.

In consideration of such points, inhibiting deviation in the pretilt angles between the substrates occurring when the liquid crystal cell is bent by differentiating the pretilt angles between the liquid crystal alignment film of one substrate and the liquid crystal alignment film of the other substrate and producing the curved surface display using the liquid crystal cell constructed by attaching these substrates has been proposed (see Patent Document 3, for example). Patent Literature 3 discloses, as a method of differentiating pretilt angles between substrates, a method of irradiating only a liquid crystal alignment film of one substrate in liquid crystal alignment films formed on the respective substrate surfaces of the pair of substrates with ultraviolet irradiation and a method of differentiating baking temperatures at the time of forming the films between the substrates.

### CITATION LIST

### Patent Literature

### [Patent Literature 1]

Japanese Unexamined Patent Application Publication No. 2003-149647

### [Patent Literature 2]

Japanese Unexamined Patent Application Publication No. 2015-99170

### [Patent Literature 3]

Japanese Unexamined Patent Application Publication No. 2005-26074

### [Non-Patent Literature 1]

Y.-J. Leeet. al. SID 09 DIGEST, p. 666 (2009)

### SUMMARY OF INVENTION

### Technical Problem

In a case in which a liquid crystal device is manufactured by differentiating pretilt angles between substrates, there is a concern that it may not be possible to secure sufficient image quality if a difference between tilt angles (tilt difference) of one substrate and the other substrate is small. Also, it is necessary to secure stable liquid crystal alignment properties in order for satisfactory display properties to be exhibited.

The present disclosure was made in view of the aforementioned problems, and an object thereof is to provide a liquid crystal device with satisfactory liquid crystal alignment properties capable of allowing a sufficient difference between pretilt angles of one substrate and the other substrate in a pair of substrates.

### Solution to Problem

The following mechanisms will be employed in the present disclosure in order to solve the problems.

According to a first configuration, there is provided a liquid crystal device including: a pair of substrates including a first substrate and a second substrate arranged to face each other; and a liquid crystal layer that is arranged between the first substrate and the second substrate, in which a liquid crystal alignment film is formed on the first substrate and the liquid crystal alignment film is not formed on the second substrate, among the first substrate and the second substrate.

With the aforementioned configuration, it is possible to set asymmetric pretilt angles between the pair of substrates by forming the liquid crystal alignment film only on one of the pair of substrates. In this manner, it is possible to sufficiently increase the tilt difference between the substrates. Therefore, it is possible to inhibit occurrence of alignment deviation due to positional deviation between upper and lower substrates and to inhibit a decrease in display quality even in a case in which external force works in a left-right direction of the substrates, due to bending of the substrates, for example. Also, since it is possible to cause an initial alignment of liquid crystal molecules to be controlled using the liquid crystal alignment film formed on the one substrate as a core, it is possible to obtain a liquid crystal device that exhibits satisfactory liquid crystal alignment properties while sufficiently increasing the tilt difference between the substrates.

According to a second configuration, the liquid crystal alignment film formed on a surface of the first substrate on a side of the liquid crystal layer is an alignment film formed of a polymer composition containing a compound that has one or more polymerizable groups, in the first configuration. Such a configuration is preferable to further increase the tilt difference between the substrates.

According to a third configuration, a layer including a water-soluble compound [B] that has at least one of a linear alkyl structure having three or more carbon atoms and an alicyclic structure is formed on the second substrate on a side of the liquid crystal layer, in the first or second configuration. The layer including the water-soluble compound [B] is preferably arranged on the substrate with no liquid crystal alignment film provided thereon on the side of the liquid crystal layer since it is then possible to further increase the tilt difference between the pair of substrates and for satisfactory liquid crystal alignment properties and a satisfactory voltage retention ratio to be exhibited.

According to a fourth configuration, the water-soluble compound [B] includes a compound having at least one type of functional group selected from a group consisting of a vinyl group, an epoxy group, an amino group, a (meth)acryloyl group, a mercapto group, and an isocyanate group, in the third configuration. When at least any one of these functional groups is preferably included, this is preferable for being able to obtain satisfactory liquid crystal alignment properties and voltage retention ratio.

According to a fifth configuration, spacers extending in a direction toward the first substrate are formed on the second substrate, in the first to fourth configurations. In a liquid crystal device, a cell gap is typically secured by forming spacers on the surface of one of the pair of substrates and bringing tip ends of the spacers into contact with the outermost surface of the other substrate. At this time, it is possible to exhibit more stable liquid crystal alignment properties by forming the spacers on the side on which the liquid crystal alignment film is not formed, as in this configuration.

According to a sixth configuration, a suppressing part suppressing part mitigating misalignment of the liquid crystal layer caused by movement of a tip ends of the spacer is provided on the first substrate, in the fifth configuration. With this configuration, it is possible to inhibit occurrence of misalignment in liquid crystal at the boundary part between the substrates and the liquid crystal layer even in a situation in which stress works on the upper and lower substrates and deviation between the substrates occurs in a width direction. In this manner, it is possible to inhibit occurrence of alignment failures and thus to obtain satisfactory display quality.

In particular, this configuration can be preferably applied to a liquid crystal device of the PSA scheme in which a liquid crystal layer is formed of a liquid crystal composition containing a photopolymerizable monomer, the liquid crystal is brought into an initial alignment state after construction of a liquid crystal cell, and the liquid crystal cell is irradiated with light. That is, the liquid crystal device of the PSA scheme has a layer that is formed of the photopolymerizable monomer and an initial alignment is applied to the liquid crystal (hereinafter, also referred to as a “PSA layer”) at the boundary part between the liquid crystal layer and the substrate. Here, the PSA layer is a layer formed through photopolymerization after the construction of the liquid crystal cell and is physically brittle as compared with a liquid crystal alignment film formed using a polymer composition obtained by dispersing or dissolving a polymer such as a polyamic acid or polyimide in a solvent. Therefore, there is a concern that the PSA layer will partially peel off due to deviation of the tip ends of the spacers formed on the surfaces of the facing substrates in the left-right direction and this will lead to alignment failures in a case in which stress works on the upper and lower substrates. In view of such points, it is possible to inhibit peeling-off of the PSA layer due to the motion of the tip ends of the spacers by applying this configuration to the liquid crystal device of the PSA scheme. In this manner, it is possible to inhibit occurrence of alignment failures.

Specifically, in regard to the sixth configuration, the spacers may be formed to be shorter or longer than a gap between the first substrate and the second substrate in a region in which the spacers are arranged, and the suppressing part may be provided at a position, at which the suppressing part faces the spacers, on the first substrate and may be in contact with the tip ends of the spacers, as in a seventh configuration.

According to an eighth configuration, the liquid crystal layer has negative dielectric anisotropy in the first to seventh configurations. With the liquid crystal layer having the negative dielectric anisotropy, it is possible to obtain a liquid crystal device of a vertical alignment type with a sufficiently large tilt difference between the substrates.

According to a ninth configuration, the liquid crystal layer is formed using a liquid crystal composition containing photopolymerizable monomers and has a polymer layer obtained by polymerizing the photopolymerizable monomers at a boundary part with respect to each of the pair of substrates, in the first to eighth configuration. By applying this to the PSA scheme, it is possible to obtain a liquid crystal device with a sufficiently large tilt difference between the substrates and with an enhanced effect of improving liquid crystal alignment properties.

According to a tenth configuration, the first substrate and the second substrate have a curved surface panel structure formed in a bent manner in the first to tenth configurations. Since the curved surface display is typically produced due to bending of the planer panels as described above, a decrease in transmittance, variations, display roughness, and the like tend to occur due to alignment deviation caused by positional deviation between the upper and lower substrates during the production. Therefore, it is possible to inhibit the alignment deviation caused by the positional deviation between the upper and lower substrates and to improve a product yield and display properties by applying the invention to the curved surface display.

According to an eleventh configuration, a colored layer containing at least one type selected from a group containing a quantum dot, a fluorescent substance, and a dye is formed on the second substrate. Since it is not necessary to heat the second substrate for forming the alignment film, it is possible to inhibit color degradation due to heat even if a colored layer containing at least one type selected from a group consisting of a quantum dot, a fluorescent substance, and a dye is provided on the second substrate.

According to a twelfth configuration, there is provided a method of manufacture for a liquid crystal device including a pair of substrates including a first substrate and a second substrate arranged to face each other and a liquid crystal layer that is arranged between the first substrate and the second substrate, the method including: forming a liquid crystal alignment film using a polymer composition on a surface of only the first substrate, among the first substrate and the second substrate; constructing a liquid crystal cell by arranging the first substrate and the second substrate with a liquid crystal composition including a photopolymerizable monomer therebetween such that a film formation surface of the first substrate and a substrate surface of the second substrate face one another; and irradiating the liquid crystal cell with light.

With the aforementioned configurations, it is possible to cause the initial alignment of the liquid crystal molecules to be controlled using the liquid crystal alignment film as a core by forming the liquid crystal alignment film only on one of the pair of substrates. In this manner, it is possible to exhibit stable alignment properties in the liquid crystal device of a so-called PSA scheme. Also, since a sufficient difference occurs between the pretilt angles of the pair of substrates, it is possible to avoid alignment deviation due to positional deviation between the upper and lower substrates in the left-right direction and thereby to improve display properties.

According to a thirteenth configuration, the polymer composition contains a compound that has one or more polymerizable groups, in the twelfth configuration. Also, according to a fourteenth configuration, the method further includes: arranging a layer including the water-soluble compound [B] on a surface of the second substrate.

According to a fifteenth configuration, the method further includes: dropping the liquid crystal composition on one of the first substrate and the second substrate using an ink-jet application device, in any of the twelfth to fourteenth configurations. According to a sixteenth configuration, the method further includes: dropping the liquid crystal composition on one of the first substrate and the second substrate such that a distance between dropping points of liquid droplets is equal to or less than 1 mm using a liquid crystal dropping device.

### BRIEF DESCRIPTION OF DRAWINGS

The aforementioned objectives, other objectives, features, and advantages of the present disclosure will become clearer from the following detailed description with reference to the accompanying drawings.

FIG. 1 is a sectional view of a liquid crystal device according to a first embodiment.

FIG. 2 is a sectional view illustrating a method of manufacture for the liquid crystal device according to the first embodiment.

FIG. 3 is an enlarged sectional view of a spacer portion of a liquid crystal device according to a second embodiment.

FIG. 4 is an enlarged sectional view of a spacer portion of a liquid crystal device according to a third embodiment.

### DESCRIPTION OF EMBODIMENTS

### First Embodiment

Hereinafter, a first embodiment of a liquid crystal device and a method of manufacture therefor will be described with reference to the drawings. Note that the same reference numerals will be applied to the same or equivalent portions in the drawings across the respective embodiments described below and description of portions with the same reference numerals will not be repeated.

### (Configuration of Liquid Crystal Device 10)

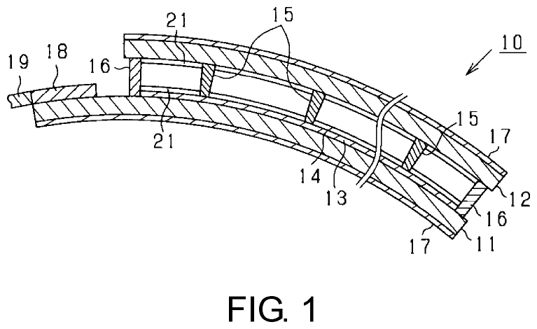

A liquid crystal device 10 according to the embodiment is of a polymer sustained alignment (PSA) mode type and is a curved surface display that has a curved surface panel structure in which substrates are formed in a bent manner. In a display unit included in the liquid crystal device 10, a plurality of pixels are arranged in a matrix shape. The liquid crystal device 10 includes a pair of substrates including a first substrate 11 and a second substrate 12, and a liquid crystal layer 14 arranged between the pair of substrates as illustrated in FIG. 1.

The first substrate 11 is a TFT substrate, and various wirings such as scanning signal lines and video signal lines, a thin film transistor (TFT) that serves as a switching element, a pixel electrode formed of a transparent conductive element such as indium tin oxide (ITO), and a flattened film (passivation layer) are provided on a glass substrate. Also, the second substrate 12 is a facing substrate, and a color filter that serves as a colored layer, a black matrix that serves as a light blocking layer, a common electrode formed of a transparent conductive element such as ITO, and an overcoated layer are provided on a glass substrate. The color filter is formed using a coloring agent such as a pigment, a quantum dot, a fluorescent substance, or a dye. The thickness of the substrate is arbitrarily set and ranges from 0.001 to 1.5 mm, for example. Note that a transparent plastic substrate or the like may be used instead of the glass substrate, for example.

A liquid crystal alignment film 13 that regulates an alignment of liquid crystal is formed on an electrode formation surface of the first substrate 11. The liquid crystal alignment film 13 is formed using a polymer composition for forming an alignment film (hereinafter, also referred to as a “liquid crystal alignment agent”). The film thickness of the liquid crystal alignment film 13 ranges from about 0.001 μm to about 1 μm, for example. Meanwhile, the liquid crystal alignment film is not formed on the surface of the second substrate 12.

The first substrate 11 and the second substrate 12 are arranged with a predetermined gap therebetween (cell gap) such that a surface of the first substrate 11 on which the liquid crystal alignment film 13 is formed and an electrode formation surface of the second substrate 12 face one another. The cell gap ranges from 1 μm to 5 μm, for example. Peripheral edges of the pair of substrates that are arranged such that the substrates face one another are attached to each other via a sealing material 16. As a material of the sealing material 16, a material known as a sealing material for a liquid crystal device (for example, thermosetting resin or photocurable resin) is used. A space surrounded by the first substrate 11, the second substrate 12, and the sealing material 16 is filled with a liquid crystal composition, and in this manner, the liquid crystal layer 14 is arranged in contact with the liquid crystal alignment film 13. In the embodiment, the liquid crystal layer 14 is formed using a liquid crystal composition containing a photopolymerizable monomer.

The liquid crystal layer 14 has negative dielectric anisotropy. Note that a configuration in which the liquid crystal layer 14 has positive dielectric anisotropy may be employed. The liquid crystal layer 14 has PSA layers 21 that are polymer layers obtained by the photopolymerizable monomer in the liquid crystal composition being polymerized, at the boundary part with respect to each of the first substrate 11 and the second substrate 12. The PSA layers 21 are formed by photopolymerizing the photopolymerizable monomer mixed into the liquid crystal layer 14 in advance in a state in which liquid crystal molecules are pretilt-aligned after a liquid crystal cell is constructed. In the liquid crystal device 10, an initial alignment of the liquid crystal molecules in the liquid crystal layer 14 is controlled by the PSA layers 21.

On the electrode formation surface of the second substrate 12, a plurality of spacers 15 extending toward the first substrate 11 are formed. The spacers 15 are columnar photospacers and are arranged in a line at predetermined intervals in a direction along the substrate surface. Note that the columnar shape includes a circular columnar shape, a polygonal columnar shape, a tapered shape, and the like, and FIG. 1 illustrates an example of the tapered shape. Tip ends of the spacers 15 are in contact with the first substrate 11, and this maintains a constant gap (cell gap) between the first substrate 11 and the second substrate 12.

In a case of a curved surface display, so-called black column spacers with light blocking properties imparted by a light blocking agent such as a carbon black are preferably used as the spacers 15. Although light leakage due to positional deviation between the substrates tends to occur at the bent ends in the liquid crystal panel with a complicated shape such as a curved surface display, the black column spacers can sufficiently inhibit such light leakage, which is preferable. Note that although the spacers 15 are columnar photospacers in the embodiment, the embodiment is not limited thereto and may employ bead spacers, for example.

In the liquid crystal device 10, polarizing plates 17 are arranged on the outer sides of the first substrate 11 and the second substrate 12. A terminal region 18 is provided at an outer edge of the first substrate 11, and the liquid crystal device 10 is driven by a driver IC 19 or the like for driving the liquid crystal being connected to the terminal region 18.

### (Method of Manufacture for Liquid Crystal Device 10)

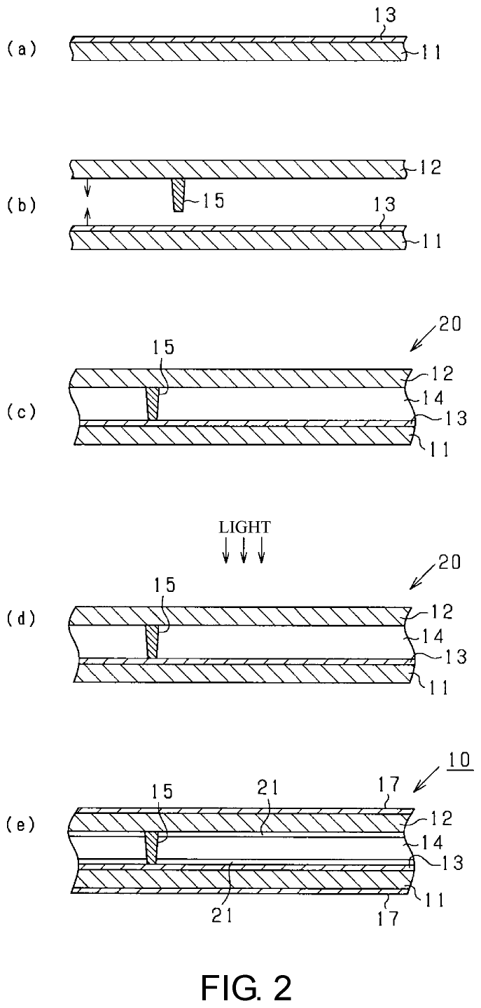

Next, a method of manufacture for a liquid crystal device 10 according to the embodiment will be described with reference to FIG. 2. The manufacture method includes the following processes A to C:

Process A: a process of forming the liquid crystal alignment film 13 on the surface of only one of the first substrate 11 and the second substrate 12 (the first substrate 11 in the embodiment) using the liquid crystal alignment agent;
Process B: a process of constructing the liquid crystal cell 20 by arranging the first substrate 11 and the second substrate 12 via the layer made of the liquid crystal composition including the photopolymerizable monomer such that the film formation surface of the first substrate 11 on which the liquid crystal alignment film 13 is formed and the electrode formation surface of the second substrate 12 face one another; and
Process C: a process of irradiating the liquid crystal cell 20 with light.

In order to manufacture the liquid crystal device 10, the liquid crystal alignment film 13 is formed on the first substrate 11 in the process A first (see FIG. 2(a)). Specifically, a coated film is formed on the electrode formation surface of the first substrate 11 by applying the liquid crystal alignment agent thereto by an offset printing method, an ink jet printing method, or the like, for example, first. Next, preheating (pre-baking) is preferably performed for the purpose of preventing dripping of the applied liquid crystal alignment agent and burning (post-baking) is performed for the purpose of completely removing the solvent in the coated film. The pre-baking temperature at this time preferably ranges from 30 to 200° C., and the pre-baking time preferably ranges from 0.25 to 10 minutes. Also, the post-baking temperature preferably ranges from 80 to 300° C., and the post-baking time preferably ranges from 5 to 200 minutes.

As the liquid crystal alignment agent, a polymer composition obtained by dispersing or dissolving, in an organic solvent, one type or two or more types of polymer constituent such as a polyamic acid, a polyimide, a polyamic acid ester, a polyamide, a polyorganosiloxane, and a poly(meth)acrylate, for example, is used. A known alignment agent that can be applied to the PSA mode can be used as the liquid crystal alignment agent, and for example, a liquid crystal alignment agent or the like including a polymer capable of causing the liquid crystal to be vertically aligned relative to the substrate surface may be exemplified. As such a polymer, a polymer that has a side chain that causes the liquid crystal to be vertically aligned is preferably used, and examples thereof include a polyamic acid having such a side chain, an imidized polymer thereof, and the like.

Although the side chain that causes the liquid crystal to be vertically aligned is not particularly limited as long as the side chain has a structure capable of vertically aligning the liquid crystal relative to the substrate, examples thereof include a linear alkyl group having 3 to 30 carbon atoms, a group having a cyclic structure in the middle of a linear alkyl group and a steroid group, a group obtained by replacing a part or all of hydrogen atoms in these groups with fluorine atoms, and the like. The side chain that causes the liquid crystal to be vertically aligned may be linked directly to the main chain of the polymer such as a polyamic acid or a polyimide or may be linked thereto via an appropriate linking group.

Specific examples of such a polymer includes a polyamic acid, polyimide, polyorganosiloxane, and the like disclosed in Japanese Unexamined Patent Application Publication No. 2015-232109, Japanese Unexamined Patent Application Publication No. 2014-112192, Japanese Patent No. 3757514, Japanese Patent No. 5109371, and Japanese Unexamined Patent Application Publication No. 2010-97188. Note that one type or two or more types of the polymer constituents may be contained in the liquid crystal alignment agent.

The liquid crystal alignment agent that is used for forming the liquid crystal alignment film 13 preferably includes a compound that has one or more polymerizable groups (hereinafter, also referred to as a “polymerizable compound (A)”). The polymerizable compound (A) is preferably contained in the liquid crystal alignment agent since it is then possible to further increase the tilt difference between the substrates and the liquid crystal alignment properties are further stabilized.

The polymerizable groups included in the polymerizable compound (A) are preferably groups that can be polymerized with light or heat, and examples thereof include a (meth)acryloyl group, a vinyl group, an allyl group, a styrene group, a maleimide group, a vinyloxy group, an ethynyl group, and the like. The polymerizable compound (A) is preferably polyfunctional, and a compound that has a total of two or more of at least either of an acryloyl groups or a methacryloyl group is preferably used in terms of high polymerizability.

The polymerizable compound (A) may be a polymer constituent or an additive. Specific examples of a case in which the polymerizable compound (A) is a polymer constituent include a polyamic acid, a polyimide, and the like disclosed in Japanese Unexamined Patent Application Publication No. 2015-232109 and Japanese Unexamined Patent Application Publication No. 2014-112192. In the case in which the polymerizable compound (A) is a polymer constituent, a blending ratio thereof is preferably equal to or greater than 50% by mass and is further preferably equal to or greater than 60% by mass with respect to the total amount of the polymer constituents in the liquid crystal alignment agent.

In a case in which the polymerizable compound (A) is an additive, it is preferable to include a structure represented by Formula (B-I) described below in molecules in order to improve a response speed and display properties of the liquid crystal molecules and long-term reliability.

—X¹¹—Y¹¹—X¹²— . . . (B-I)

(In Formula (B-I), X¹¹ and X¹² each independently represent 1,4-phenylene group or a 1,4-cyclohexylene group, and Y¹¹ represents a divalent hydrocarbon group of a single bond having 1 to 4 carbon atoms, —COO—CₙH₂ₙ—OCO— (n is an integer from 1 to 10), an oxygen atom, a sulfur atom, or —COO—. However, X¹¹ and X¹² may be substituted with one or more alkyl groups having 1 to 30 carbon atoms, a fluoroalkyl group having 1 to 30 carbon atoms, an alkoxy group having 1 to 30 carbon atoms, a fluoroalkoxy group having 1 to 30 carbon atoms, a fluorine atom, or a cyano group.)

The photopolymerizable monomer preferably has a long-chain alkyl structure in a side chain in terms of a response speed and liquid crystal alignment properties of the liquid crystal molecules. The long-chain alkyl structure is preferably any of an alkyl group having 3 to 30 carbon atoms, a fluoroalkyl group having 3 to 30 carbon atoms, an alkoxy group having 3 to 30 carbon atoms, and a fluoroalkoxy group having 3 to 30 carbon atoms. Among these examples, the long-chain alkyl structure preferably has 5 or more carbon atoms and more preferably has 10 or more carbon atoms. The long-chain alkyl structure is preferably introduced into any of X¹¹ and X¹² in Formula (B-I) described above in the photopolymerizable monomer.

Specific examples in a case in which the photopolymerizable compound (A) is an additive include di(meth)acrylate having a biphenyl structure, a di(meth)acrylate having a phenyl-cyclohexyl structure, a di(meth)acrylate having a 2,2-diphenylpropane structure, a di(meth)acrylate having a diphenylmethane structure, a di-thio(meth)acrylate having a diphenyl thioether structure, and the like.

Specific examples thereof include: as a di(meth)acrylate having a biphenyl structure, 4′-(meth)acryloyloxy-biphenyl-4-yl-(meth)acrylate, 4′-(meth)acryloyloxy-3′-octylbiphenyl-4-yl-(meth)acrylate, 4′-(meth)acryloyloxy-3′-hexadecylbiphenyl-4-yl-(meth)acrylate, 2-[4′-(2-(meth)acryloyloxy-ethoxy)-biphenyl-4-yloxy]-ethyl(meth)acrylate, [1,1′-biphenyl]-4,4′-diylbis(2-(meth)acrylate), 4-((2-(meth)acryloyloxy)ethoxy)carbonyl)phenyl 4′-((meth)acryloyloxy)-[1,1′-biphenyl]-4-carboxylate, 4-((meth)acryloyloxy)phenyl 4′-((4-((meth)acryloyloxy)benzoyl)oxy)-[1,1′-biphenyl]-4-carboxylate, bishydroxyethoxybiphenyldi(meth)acrylate, 2-(2-{4′-[2-(2-(meth)acryloyloxy-ethoxy)-ethoxy]-biphenyl-4-yloxy}-ethoxy)-ethyl(meth)acrylate, di(meth)acrylate of an ethylene oxide adduct of biphenyl, di(meth)acrylate of a propylene oxide adduct of biphenyl, 2-(4′-(meth)acryloyloxy-biphenyl-4-yloxy)-ethyl(meth)acrylate and the like;
as di(meth)acrylate having a phenyl-cyclohexyl structure, 4-(4-(meth)acryloyloxy-phenyl)-cyclohexyl(meth)acrylate, 2-(4-(4-((meth)acryloyloxy)cyclohexyl)phenoxy)ethyl(meth)acrylate, 2-{4-[4-(2-(meth)acryloyloxy-ethoxy)-phenyl]-cyclohexyloxy}-ethyl(meth)acrylate, 2-[2-(4-{4-[2-(2-(meth)acryloyloxy-ethoxy)-ethoxy]-phenyl}-cyclohexyloxy)-ethoxy]-ethyl(meth)acrylate, and the like;

as a di(meth)acrylate having a 2-2-diphenylpropane structure, 4-[1-(4-(meth)acryloyloxy-phenyl)-1-methyl-ethyl]-phenyl(meth)acrylate, 2-(4-{1-[4-(2-(meth)acryloyloxy-ethoxy)-phenyl]-1-methyl-ethyl}-phenoxy)-ethyl(meth) acrylate, bishydroxyethoxy-bisphenol A di(meth)acrylate, 2-{2-[4-(1-{4-[2-(2-(meth)acryloyloxy-ethoxy)-ethoxy]-phenyl}-1-methyl-ethyl)-phenoxy]-ethoxy}-ethyl(meth)acrylate, di(meth)acrylate of an ethylene oxide adduct of bisphenol A, a di(meth)acrylate of a propylene oxide adduct of bisphenol A, 2-(4-{1-[4-(2-(meth)acryloyloxy-propoxy)-phenyl]-1-methyl-ethyl}-phenoxy)-1-methyl-ethyl(meth)acrylate, and the like;

as a di(meth)acrylate having a diphenylmethane structure, 4-(4-(meth)acryloyloxy-benzyl)-phenyl(meth)acrylate, 2-{4-[4-(2-(meth)acryloyloxy-ethoxy)-benzyl]-phenyl}-ethyl(meth)acrylate, di(meth)acrylate of an ethylene oxide adduct of bisphenol F, di(meth)acrylate of a propylene oxide adduct of bisphenol F, 2-[2-(4-{4-[2-(2-(meth)acryloyloxy-ethoxy)-ethoxy]-benzyl}-phenoxy)-ethoxy]-ethyl(meth)acrylate, 2-{4-[4-(2-(meth)acryloyloxy-propoxy)-benzyl-phenoxy}-1-methyl-ethyl(meth)acrylate, 2-[2-(4-{4-[2-(2-(meth)acryloyloxy-propoxy)-propoxy]-benzyl}-phenoxy)-1-methyl-ethoxy]-1-methyl-ethylethyl(meth)acrylate, and the like;

as di-thio(meth)acrylate having a diphenyl thioether structure, 4-(4-thio(meth)acryloylsulfanyl-phenylsulfanyl)-phenyldithio(meth)acrylate, bis(4-methacryloylthiophenyl)sulfide, and the like; and as other compounds, pentane-1,5-diylbis(4-((meth)acryloyloxy))benzoate, 2,5-bis{4-(3-acryloyloxy-propoxy)-benzoic acid}toluene, and the like.

In the case in which the polymerizable compound (A) is an additive, the content ratio of the polymerizable compound (A) preferably ranges from 1 to 100 parts by mass and more preferably ranges from 5 to 50 parts by mass with respect to a total of 100 parts by mass of the polymer constituent included in the liquid crystal alignment agent. Note that one type of polymerizable compound (A) may be used alone or two or more types of polymerizable compounds (A) may be used in combination.

The spacers 15 are formed on the electrode formation surface of the second substrate 12 (see FIG. 2(b)). As a method of forming the spacers 15, a photolithography method, a dispenser method, a screen printing method, and the like are exemplified, for example. Among these examples, the photolithography method is preferably used. The height, the width, the number of the spacers 15 are appropriately selected in accordance with the size of the substrate, the cell gap, and the like. Note that no liquid crystal alignment film is formed on the second substrate 12 and the processing proceeds to the next process B. The first substrate 11 and the second substrate 12 may be cleaned before the liquid crystal alignment film is formed, or the substrate surfaces thereof on which no liquid crystal alignment film has been formed may be cleaned, with a cleaning solution such as ultrapure water.

Although detailed description will be omitted here since a known method can be used as the method of forming the spacers 15 by the photolithography method, the spacers 15 is typically formed by a method including a film formation process, a radiation process, and a development process. First, a coated film is formed by applying a radiation sensitive resin composition for spacers to the substrates in the film formation process. In a case in which the radiation sensitive resin composition includes a solvent, the solvent is preferably removed by pre-baking the coated surface. A known material can be used as the radiation sensitive resin composition for spacers, and for example, it is possible to prepare the radiation sensitive resin composition by appropriately selecting and mixing a binder polymer, a photopolymerization initiator, a light blocking agent, and the like as disclosed in Japanese Unexamined Patent Application Publication No. 2015-069181, for example. It is possible to apply the description in Japanese Unexamined Patent Application Publication No. 2015-069181, for example, for the types and the blending ratios of the respective constituents blended in the radiation sensitive resin composition for spacers.

In the radiation process for forming the spacers, at least a part of the coated film is irradiated with radiation and is exposed to light. The light exposure is performed via a photomask that has a predetermined pattern in accordance with the shapes of the spacers 15. Then, the coated film which has been irradiated with radiation is developed (development process). In this manner, an unnecessary part (a part irradiated with the radiation in a case of a positive type) is removed, and the plurality of spacers 15 are formed at predetermined intervals in a direction along the substrate surface. As a development solution, an alkaline aqueous solution is preferably used. After the development, a heating process of heating the coated film may be included. The heating makes it possible to sufficiently remove the development solution, and a hardening reaction of the binder polymer is promoted as needed.

In the following process B, the first substrate 11 and the second substrate 12 are arranged such that the film formation surface of the first substrate 11 on which the liquid crystal alignment film 13 has been formed and the spacer formation surface of the second substrate 12 face each other (see FIG. 2(b)) to obtain a state in which tip ends of the spacers 15 are in contact with the first substrate 11. In this manner, the liquid crystal cell 20 with the liquid crystal layer 14 is constructed (see FIG. 2(c)).

The liquid crystal layer 14 is formed by dropping or applying a liquid crystal composition to the one substrate to which the sealing material 16 has been applied and then attaching the other substrate thereto. At that time, a method of dropping the liquid crystal composition using a liquid crystal dropping device (one drop filling (ODF) device) such that the distance between dropping points of liquid droplets is equal to or less than 3 mm or a method of dropping the liquid crystal composition using an ink jet application device is preferably used since it is possible to preferably inhibit application irregularity (ODF irregularity) of the liquid crystal alignment agent. In the former case, the distance between the dropping points of the liquid droplets is preferably equal to or less than 1 mm, is further preferably equal to or less than 0.8 mm, and is particularly preferably equal to or less than 0.5 mm. However, the method of forming the liquid crystal layer 14 is not limited to the aforementioned methods, and a method of attaching peripheral edges of the pair of substrates arranged to face each other with the cell gap interposed therebetween via the sealing material 16, pouring the liquid crystal composition into the cell gap surrounded by the substrate surfaces and the sealing material 16, filling the cell gap with the liquid composition, and the sealing the pouring hole may be employed, for example. Processing of removing a flowing alignment at the time of liquid crystal filling may further be performed on the thus produced liquid crystal cell 20 by heating the liquid crystal cell 20 to a temperature at which the used liquid crystal is in an isotropic phase and performing annealing processing of gradually cooling the liquid crystal cell 20 to a room temperature. From a viewpoint of further increasing the tilt difference between the pair of substrates in the obtained liquid crystal device 10, it is preferable not to perform the annealing processing before the irradiation of the liquid crystal cell 20 with light in the process C.

As the photopolymerizable monomer blended in the liquid crystal layer 14, a compound that has two or more (meth)acryloyl groups can preferably be used in terms of high photopolymerization properties. As specific examples of the photopolymerizable monomer, the description for the case in which the polymerizable compound (A) is an additive can be applied. The blending ratio of the photopolymerizable monomer preferably ranges from 0.1 to 0.5% by mass with respect to the total amount of the liquid crystal composition used to form the liquid crystal layer 14. Note that one type of photopolymerizable monomer may be used alone or two or more types of photopolymerizable monomers may be used in combination.

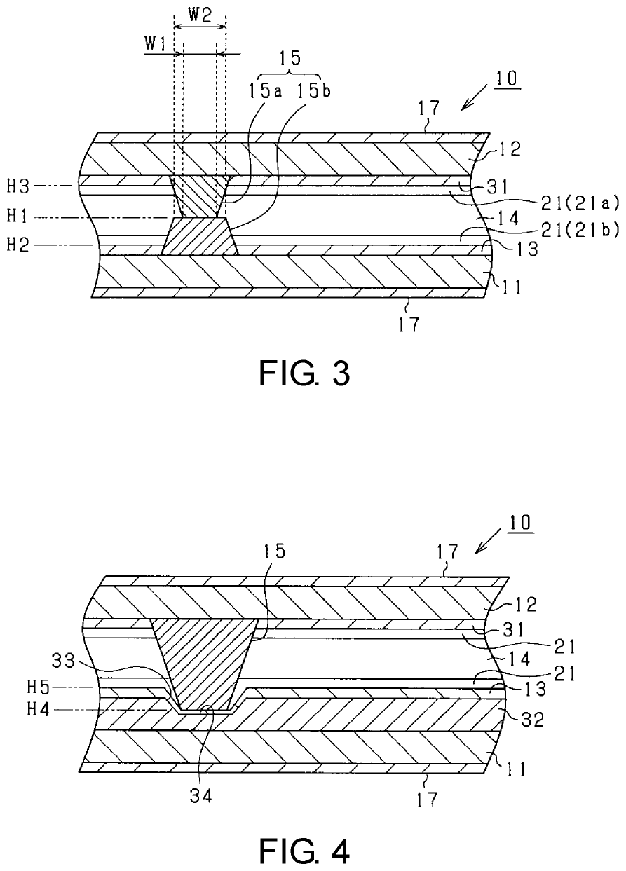

In the following process C, the liquid crystal cell 20 obtained in the process B is irradiated with light (see FIG. 3(c)). The irradiation of the liquid crystal cell 20 with light may be performed in a state in which no voltage is applied between electrodes, may be performed in a state in which a predetermined voltage with which the liquid crystal molecules in the liquid crystal layer 14 are not driven is applied, or in a state in which a predetermined voltage with which the liquid crystal molecules are driven is applied between the electrodes. The light irradiation is preferably performed in the state in which a voltage is applied between the electrodes that the pair of substrates have. The applied voltage can be a DC voltage or an AC voltage from 5 to 50 V, for example. Although it is possible to use ultraviolet rays and visible rays including light with a wavelength of 150 to 800 nm, for example, as the light for the irradiation, ultraviolet rays including light with a wavelength of 300 to 400 nm are preferably used. In a case in which the used irradiation is linearly polarized light or partially polarized light, a light irradiation direction may be a vertical direction relative to the substrate surfaces, may be an oblique direction, or may be a combination thereof. In a case in which non-polarized radiation is used for the irradiation, the irradiation direction is set to be the oblique direction.

As a light source for the irradiation light, a low-pressure mercury lamp, a high-pressure mercury lamp, a deuterium lamp, a metal halide lamp, an argon resonance lamp, a xenon lamp, an excimer laser, or the like can be used, for example. Note that the aforementioned ultraviolet rays in the preferable wavelength region can be obtained by a mechanism that also uses the light source as a filter grating or the like, for example. The irradiation amount of light preferably ranges from 1,000 to 200,000 J/m² and more preferably from 1,000 to 100,000 J/m².

Then, the polarized plate 17 is attached to the outer surface of the liquid crystal cell 20, thereby obtaining the liquid crystal device 10 (see FIG. 2(e)). As the polarizing plate 17, a polarized plate obtained by sandwiching a polarized film that is obtained by causing polyvinyl alcohol to absorb iodine while being aligned in a stretched manner and that is called an “H′ film with cellulose acetate protection films, or a polarized film made of the H film itself, and the like are exemplified. The thus obtained liquid crystal panel in a planar shape is bent, thereby obtaining a liquid crystal device with a curved surface panel structure.

According to the first embodiment described above in detail, it is possible to obtain asymmetric pretilt angles between the substrates and to cause a sufficient difference between the pretilt angles of the pair of substrates by forming the liquid crystal alignment film 13 only on the first substrate 11 and not forming the liquid crystal alignment film on the second substrate 12, among the pair of substrates. Therefore, it is possible to avoid alignment deviation due to positional deviation between the upper and lower substrates and to improve display properties in the curved surface display.

Also, it is possible to control the initial alignment of the liquid crystal molecules by using the liquid crystal alignment film 13 formed on the first substrate 11 as a core in the liquid crystal device 10 of the PSA scheme and thereby to obtain a liquid crystal device that exhibits stable alignment properties.

Since the liquid crystal alignment film is not formed on the second substrate 12 that is the facing substrate, it is not necessary to heat the second substrate 12 for forming the alignment film. Therefore, it is possible to inhibit color degradation of the colored layer even in a case in which the colored layer containing at least one type selected from the group consisting of a quantum dot, a fluorescent substance, and a dye is formed on the second substrate 12.

### Second Embodiment

Next, a second embodiment will be described by focusing mainly on differences from the first embodiment. A liquid crystal device 10 according to the second embodiment is different from that according to the first embodiment in that a layer made of a water-soluble compound that has at least one of a linear alkyl structure having 3 or more carbon atoms and an alicyclic structure (hereinafter, referred to as a “specific structure layer 31”) is arranged on an electrode formation surface of a second substrate 12 with no liquid crystal alignment film formed thereon such that the layer is adjacent to the liquid crystal layer 14 (more specifically, adjacent to a PSA layer 21). Note that water solubility in the specification means a characteristic of being dissolved at a ratio of 1% by mass or greater, preferably at a ratio of 5% by mass or greater, or more preferably at a ratio of 10% by mass or greater with respect to pure water at 25° C.

The liquid crystal device 10 has a curved panel structure similar to the first embodiment. The liquid crystal device 10 has a plurality of first spacers 15a formed on the surface of the second substrate 12 and a plurality of second spacers 15b formed on the surface of the first substrate 11 as spacers 15 as illustrated in FIG. 3. Note that the liquid crystal alignment film 13 is formed on the electrode formation surface of the first substrate 11, and no liquid crystal alignment film is formed on the electrode formation surface of the second substrate 12 similarly to the first embodiment.

The first spacers 15a and the second spacers 15b are columnar photospacers that project in a thickness direction of the substrates from the respective substrate surfaces, and the plurality of spacers 15 are arranged in a line at predetermined intervals at positions at which the spacers 15 overlap a black matrix when seen in the thickness direction of the liquid crystal device 10. Note that the columnar shape includes a circular columnar shape, a polygonal columnar shape, a tapered shape, and the like, and FIG. 2 illustrates an example of the tapered shape. Each of the first spacers 15a and the second spacers 15b has a height up to an intermediate position between the pair of substrates. Specifically, the first spacers 15a have a sufficient height such that the tip ends thereof project from a PSA layer 21a arranged on the second substrate 12, and the second spacers 15b have a sufficient height such that the tip ends thereof project from a PSA layer 21b arranged on the first substrate 11. In this manner, the first spacers 15a are in contact with the tip ends of the second spacers 15b on the side of the first substrate 11 beyond the PSA layer 21a, and the second spacers 15b are in contact with the tip ends of the first spacers 15a on the side of the second substrate 12 beyond the PSA layer 21b.

The second spacers 15b are formed at positions on the electrode formation surface of the first substrate 11, at which the second spacers 15b face the respective tip ends of the plurality of first spacers 15a, and a cell gap is formed by the tip ends of the first spacers 15a and the tip ends of the second spacers 15b being brought into contact with each other. As illustrated in FIG. 3, a height position H1 of the tip ends of the second spacers 15b is higher than a height position H2 at a boundary between the liquid crystal layer 14 and the first substrate 11 in the liquid crystal device 10 when seen in the thickness direction of the substrate with reference to the first substrate 11. Also, the height position H1 of the tip ends of the first spacers 15a is higher than a height position H3 at a boundary between the liquid crystal layer 14 and the second substrate 12 when seen with reference to the second substrate 12. More specifically, the first spacers 15a and the second spacers 15b are arranged such that the respective tip ends are on a further inner side than the PSA layer 21 in the liquid crystal layer 14.

Here, since the PSA layer 21 is a layer formed through the polymerization of the photopolymerizable monomer after the construction of the liquid crystal cell 20, the PSA layer 21 is physically brittle as compared with the liquid crystal alignment film 13. Therefore, there is a concern that if the tip ends of the spacers 15 are in contact with the outermost surfaces of the substrates that the tip ends face, the PSA layer 21 partially peels off due to deviation between the tip ends of the spacers 15 in the left-right direction and this leads to alignment failures in a case in which stress works on the upper and lower substrates and deviation occurs in the left-right direction of the substrates. As a situation in which such stress in the left-right direction works, vibration when the liquid crystal device 10 is delivered, bending of the substrates at the time of producing the curved surface display, and the like are considered.

In regard to this point, the end surfaces of the spacers 15 are arranged at positions away from the substrate surfaces beyond the height positions at the boundaries between the liquid crystal layer 14 and the substrates according to the configuration in which the first spacers 15a are provided on one of the pair of substrates, the second spacers 15b are provided on the other substrates, and the tip ends of the first spacers 15a and the tip ends of the second spacers 15b are brought into contact with each other to form a cell gap as described above. In this manner, rubbing of the PSA layer 21 with the end surfaces of the spacers 15 is inhibited in a case in which stress works on the upper and lower substrates and deviation occurs in the left-right direction. As a result, it is possible to inhibit occurrence of alignment failures. Note that the second spacers 15b correspond to “the suppressing part mitigating misalignment of the liquid crystal layer 14 due to movement of the tip ends of the first spacers 15a”.

Further, a width W1 of the tip ends of the first spacers 15a is different from a width W2 of the tip ends of the second spacers 15b, and the width W2 of the tip ends of the second spacers 15b is greater as illustrated in FIG. 3 in the embodiment. In this manner, the state in which the mutual end surfaces are in contact is easily retained even in a case in which stress works on the upper and lower substrates and deviation occurs in the left-right direction, and high durability against deviation stress is achieved. The tip ends of the first spacers 15a and the tip ends of the second spacers 15b are not fixed (free ends) such that the tip ends can absorb deviation stress in the left-right direction.

Note that the width W1 may be set to be greater than the width W2. Also, the width W1 and the width W2 may be set to be the same as each other, and the tip ends of the first spacers 15a and the tip ends of the second spacers 15b may be arranged to be adjacent to each other via an adhesive layer.

In the liquid crystal device 10, the specific structure layer 31 is arranged on the electrode formation surface of the second substrate 12 such that the specific structure layer 31 is adjacent to the liquid crystal layer 14. The specific structure layer 31 is preferably arranged since it is possible to further increase the tilt difference between the pair of substrates and to exhibit satisfactory liquid crystal alignment properties and voltage retention ratio.

As the water-soluble compound [B], a compound having at least one type of functional group selected from a group consisting of a vinyl group, an epoxy group, an amino group, a (meth)acryloyl group, a mercapto group, and an isocyanate group is preferably used. It is possible to further enhance an effect of improving stability of the initial alignment and the voltage retention ratio by including such functional groups.

In a case in which the water-soluble compound [B] has a linear alkyl structure having 3 or more carbon atoms, the linear alkyl structure preferably has 3 to 40 carbon atoms and more preferably has 5 to 30 carbon atoms. Specific examples of the linear alkyl structure include an alkanediyl group having 3 to 40 carbon atoms, a divalent group obtained by introducing —O—, —CO—, —COO—, —NH—, or —NHCO— at a carbon-carbon bond of an alkanediyl group, a group obtained by substituting at least one hydrogen atom in an alkanediyl group for a fluorine atom, and the like. In a case in which the water-soluble compound [B] has an alicyclic structure, the alicyclic structure may be any of monocyclic and polycyclic structures. Specific examples of the alicyclic structure include a cycloalkane structure having 5 to 20 carbon atoms, a bicycloalkane structure having 7 to 20 carbon atoms, a sterol structure (for example, a cholestanyl group, cholesteryl group, a phytosteryl group, or the like), and the like. Note that the water-soluble compound [B] may have a linear alkyl structure having 3 or more carbon atoms and a monoalicyclic or polyalicyclic structure.

Examples of such a water-soluble compound [B] include a silane coupling agent, an anionic surfactant, a nonionic surfactant, an amphoteric surfactant, nonionic surfactant, and the like. Specific examples thereof include: as silane coupling agents, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-triethoxysilylpropyltriethylenetriamine, 10-trimethoxysilyl-1,4,7-triazadecane, 9-trimethoxysilyl-3,6-diazanonylacetate, 9-trimethoxysilyl-3,6-diazanonane acid methyl, N-benzyl-3-aminopropyltrimethoxysilane, N-phenyl-3-aminopropyltrimethoxysilane, glycidoxymethyltrimethoxysilane, 2-glycidoxyethyltrimethoxysilane, 3-glycidoxypropyltrimethoxysilane, dimethyloctadecyl[3-(trimethoxysilyl)propyl] ammonium chloride, methacrylic acid 3-(trihydroxysilyl)propyl, 1,6-bis(trimethoxysilyl)hexane, benzoic 3-(trimethoxysilyl)propyl, and the like;

as anionic surfactants, sulfuric acid ester of higher alcohol, alkyl benzene sulfonate, aliphatic sulfonate, sulfuric acid ester of polyethylene glycol alkyl ether, and the like;

as nonionic surfactants, alkyl ester type, alkyl ether type, and alkyl phenyl ether type compounds of polyethylene glycol, and the like;
as amphoteric surfactant, surfactants that have carboxylate, a sulfuric acid ester salt, sulfonate, or a phosphoric acid ester salt as an anionic part and have an amine salt or a quaternary ammonium salt as a cationic part, specifically, betaines such as laurylbetaine, stearylbetaine, amino acid types such as lauryl-β-alanine, stearyl-β-alanine, lauryldi(aminoethyl)glycine, and octyldi(aminoethy)grycine; and
as nonionic surfactants, POE cholesterol ether, POE/POP cholesterol ether, POE/POP/POB cholesterol ether, POE/POB cholesterol ether, POE hytosterol ether, POE/POP phytosterol ether, POE phytostanol ether, POE/POP phytostanol ether (where POE represents a polyoxyethylene group, POP represents a polyoxypropylene group, and POB represents a polyoxybutylene group). Note that one kind of water-soluble compound [B] may be used alone or two or more types of water-soluble compound [B] may be used in combination.

As the water-soluble compound [B], at least one type selected from a group consisting of a silane coupling agent, an anionic surfactant, and a nonionic surfactant is preferably used, and a nonionic surfactant or a silane coupling agent is particularly preferably used among these examples since it is possible to obtain more satisfactory liquid crystal alignment properties.

Although a method of forming the specific structure layer 31 is not particularly limited, a method of preparing a solution by dissolving the water-soluble compound [B] in a solvent such as water, applying the prepared solution to the substrate, and drying the prepared solution is preferably used. An application method is not particularly restricted, and examples thereof include a soaking method, a dipping method, a spin coating method, a brush painting method, a shower method, and the like. Such processing of forming the specific structure layer 31 is preferably performed as a part of the cleaning process for the purpose of removing foreign matters on the substrate since it is possible to simplify the processes.

Specifically, the water-soluble compound [B] is blended in a cleaning solution (for example, pure water) for the substrate first, and the cleaning solution is applied to at least the electrode formation surface of the second substrate 12 on which the liquid crystal alignment film has not been formed, thereby forming a coated film. Note that the cleaning processing of the substrate (the processing of forming the specific structure layer 31) may be performed before the spacer formation process or may be performed after the spacer formation process. The blending ratio of the water-soluble compound [B] in the cleaning solution is preferably equal to or less than 5% by mass, preferably ranges from 0.1 to 2.5% by mass, and further preferably ranges from 0.5 to 1% by mass. The method of soaking the second substrate 12 in the cleaning solution is preferably used in terms of cleaning efficiency. The soaking time ranges from 5 minutes to 2 hours, for example. Thereafter, drying is performed through heating or wind drying as needed, thereby obtaining the second substrate 12 with a thin film formed of the water-soluble compound [B].

Note that the specific structure layer 31 may also be formed on the surface of the first substrate 11 on which the liquid crystal alignment film 13 has been formed in the second embodiment. In this case, the specific structure layer 31 is preferably arranged between the first substrate 11 and the liquid crystal alignment film 13. In the liquid crystal device 10 according to the first embodiment, the specific structure layer 31 may be formed on the electrode formation surface of the second substrate 12.

Although the contact surfaces of the first spacers 15a and the second spacers 15b may have flat shapes as illustrated in FIG. 3, the shapes of the contact surfaces are not particularly limited, and uneven shapes may be formed, for example.

### Third Embodiment

Next, a third embodiment will be described by focusing mainly on differences from the second embodiment. In the second embodiment, the first spacers 15a and the second spacers 15b are provided as the spacers 15, and the second spacers 15b serve as the suppressing part. Meanwhile, according to the embodiment, a resin layer with no liquid crystal alignment capability is formed on a first substrate 11, and tip ends of spacers 15 formed on a second substrate 12 are brought into contact with recess parts provided in the resin layer, thereby differentiating height positions of the respective tip ends of the spacers 15 formed on the second substrate 12 from height positions at a boundary between a liquid crystal layer 14 and the first substrate 11. In this manner, misalignment in the liquid crystal layer 14 due to movement of the tip ends of the spacers 15 is inhibited.

Specifically, columnar spacers 15 are formed on the electrode formation surface of the second substrate 12 by a photolithography method, for example, as illustrated in FIG. 4. Note that the second substrate 12 does not have a liquid crystal alignment film similarly to the first embodiment and the second embodiment. A resin layer 32 that serves as an insulating flattened film and a liquid crystal alignment film 13 are arranged on the first substrate 11, and the liquid crystal alignment film 13 is in a state in which the liquid crystal alignment film 13 is adjacent to the liquid crystal layer 14. The thickness of the resin layer 32 ranges from 0.01 μm to 1 μm, for example.

In the resin layer 32, recess parts 33 are formed at positions at which the recess parts 33 face the respective tip ends of the plurality of spacers 15 formed on the second substrate 12. The spacers 15 are formed to be longer than a gap between the first substrate 11 and the second substrate 12 in a region in which the spacers 15 are arranged. The tip ends of the respective spacers 15 are fitted into the recess parts 33 at facing positions and are in contact with bottom surfaces 34 of the recess parts 33. In this manner, the end surfaces of the tip ends of the spacers 15 abut on the bottom surfaces 34 such that a cell gap between the pair of substrates is retained. As illustrated in FIG. 4, a height position H4 of the tip ends of the respective spacers 15 relative to the first substrate 11 that is regarded as a reference is lower than a height position H5 at the boundary between the liquid crystal layer 14 and the first substrate 11. In this manner, PSA layers 21 on the facing substrate surfaces do not peel off in a case in which the tip ends of the spacers 15 move in the left-right direction. Note that the recess parts 33 correspond to “the suppressing part mitigating misalignment in the liquid crystal layer 14 due to movement of the tip ends of the spacers 15”.

Note that since a liquid crystal alignment agent is accumulated in the recess parts 33 if the liquid crystal alignment agent is applied to the surface of the resin layer 32, and it is considered that the liquid crystal alignment film 13 has a thick thickness at the recess parts 33, it is preferable to use a spin coating method or to mask the recess parts 33 and apply the liquid crystal alignment agent when the liquid crystal alignment agent is applied to the substrate in the embodiment.

The resin layer 32 is preferably formed by the photolithography method using a radiation sensitive resin composition including photosensitive resin. The recess parts 33 of the resin layer 32 can be formed by the photolithography method using a halftone mask, for example. The halftone mask performs intermediate exposure using a semitransmissive film. Three exposure levels, namely an “exposed portion”, an “intermediate exposure portion”, and an “unexposed portion” are expressed in exposure performed once, and it is possible to form a resin layer with a plurality of thicknesses after the development. Since it is possible to perform exposure in a plurality of grayscales by adjusting the amount of passing or transmitting light at the “intermediate exposure portion”, it is possible to express three or more exposure levels in exposure performed once.

In a case in which positive-type photosensitive resin is exposed, for example, an exposed portion that has been changed to be soluble in the development agent is moved, and an unexposed portion remains by performing development processing on the resin layer exposed using the halftone mask. Here, since only the upper layer portion of the resin layer 32 corresponding to the semitransmissive region is exposed, only the upper layer portion is removed through the development processing, and the recess parts 33 are formed. As the radiation sensitive resin composition to form the resin layer 32, it is possible to use a composition that is used to form a flattened film and an interlayer insulating film, and for example, it is possible to use the radiation sensitive resin compositions and the like disclosed in Japanese Unexamined Patent Application Publication No. 2013-029862, Japanese Unexamined Patent Application Publication No. 2010-217306, and Japanese Unexamined Patent Application Publication No. 2016-151744. Note that the resin layer 32 is not limited to the positive type resin layer and it is also possible to apply the photolithography method using the halftone mask to the negative type to form the recess parts 33.

According to the embodiment, it is possible to prevent the tip ends of the spacers 15 from being brought into contact with the PSA layer 21 by the tip ends of the spacers 15 being arranged such that the tip ends are fitted into the recess parts 33. Also, the tip ends of the spacers 15 are preferably fitted into the recess parts 33 since the state in which the tip ends of the spacers 15 are fitted into the recess parts 33 is easily retained and durability against deviation stress can be maintained to be high even in a case in which stress works on the upper and lower substrates and deviation occurs in the left-right direction.

In the third embodiment, the resin layer 32 may be provided only in a region corresponding to a part including the positions that face the respective tip ends of the plurality of spacers 15 formed on the second substrate 12 without providing the resin layer 32 on the entire substrate surface. In addition, a configuration in which the specific structure layer 31 is not provided in the liquid crystal device 10 may be used. Alternatively, the specific structure layer 31 may also be formed on the side of the first substrate 11 on which the liquid crystal alignment film 13 has been formed.

### Other Embodiments

Although the recess parts 33 are provided on the resin layer 32 at the positions that face the respective tip ends of the plurality of spacers 15 formed on the surface of the second substrate 12 on the side of the liquid crystal layer 14 in the third embodiment, protrusions that protrude in a direction toward the second substrate may be provided instead of the recess parts 33. In this case, it is also possible to differentiate the height position of the respective tip ends of the spacers 15 formed on the second substrate 12 from the height position at the boundary between the liquid crystal layer 14 and the first substrate 11.

The configuration of the suppressing part is not limited to the configurations in the aforementioned second and third embodiments. For example, movement of the spacers 15 may be inhibited by forming an annular protrusion surrounding the outer periphery of the tip ends of the spacers 15 on the first substrate 11 and fitting the tip ends of the spacers 15 on an inner peripheral side of the protrusion in the aforementioned first embodiment. The protrusion may be formed of a material that is the same as the material of a semiconductor layer, a source electrode, and a drain electrode of the TFT in the TFT production process.

Although the case in which the liquid crystal layer 14 is formed using the liquid crystal composition containing the photopolymerizable monomer and the configuration is applied to the PSA mode in which the liquid crystal cell is irradiated with light while the liquid crystal is brought into the predetermined initial alignment state has been described in the first to third embodiments, the configuration may be applied to a mode (SS-VA mode) in which the liquid crystal cell is irradiated with light while the liquid crystal is brought into the predetermined initial alignment state by mixing the photopolymerizable monomer into the liquid crystal alignment film rather than the liquid crystal layer 14.

Although the case in which the configuration is applied to the curved surface display has been described in the first to third embodiments, the configuration may be applied to a liquid crystal device with a planar panel structure in which the first substrate 11 and the second substrate 12 have planar shapes.

The liquid crystal device 10 of the present invention described above in detail can be effectively applied to various applications, and can also be used in various kinds of display devices and light control devices of, for example, watches, portable game machines, word processors, notebook type personal computers, car navigation systems, camcorders, PDAs, digital cameras, mobile telephones, smartphones, various types of monitors, liquid crystal televisions, information displays, and the like.

### EXAMPLE

Hereinafter, although the present disclosure will be specifically described with reference to examples, the disclosure is not limited to these examples.

In the examples, an imidation ratio of polymer polyimide was measured by the following method.

[Imidation ratio of polyimide]: An aqueous solution of polyimide was poured into pure water, an obtained deposit was sufficiently decompressed and dried at a room temperature and was dissolved in deuterated dimethyl sulfoxide, and ¹H-NMR was measured at the room temperature using tetramethylsilane as a reference substance. The imidation ratio [%] was obtained by the formula represented as Formula (1) below from the obtained ¹H-NMR spectrum.

Imidation ratio [%]=(1−A¹/A²×α)×100 (1)

(In formula (1), A¹ represents a peak area derived from a proton of an NH group appearing around a chemical shift of 10 ppm, A² represents a peak area derived from other protons, and α represents the proportion of the number of protons with respect to one proton of an NH group in a precursor (polyamic acid) of a polymer.)

### <Synthesis of Polymer>

### Synthesis Example 1

100 molar parts of 2,3,5-tricarboxy cyclopentyl acetic dianhydride as tetracarboxylic dianhydride, 70 molar parts of 4,4′-diaminodiphenylether as diamine, and 30 molar parts of 3,5-diaminobenzoic acid cholestanyl were dissolved in N-methyl-2-pyrrolidone (NMP), and reaction was caused at 60° C. for 6 hours, thereby obtaining a solution containing 10% by mass of polyamic acid (this will be referred to as a polymer (PA-1)).

### Synthesis Example 2

100 molar parts of 2,3,5-tricarboxy cyclopentyl acetic dianhydride as tetracarboxylic dianhydride, 80 molar parts of 3,5′-diaminobenzoic acid as diamine, and 20 molar parts of cholestanyloxy-2,4-diaminobenzen were dissolved in NMP, and reaction was caused at 60° C. for 6 hours, thereby obtaining a solution containing 20% by mass of polyamic acid. NMP was added to the obtained polyamic acid solution to obtain a solution of 7% by mass of polyamic acid, 0.1 times molar of pyridine and 0.1 times molar of acetic anhydride were added to the total amount of used tetracarboxylic dianhydride, and a dewatering cyclization reaction was caused at 110° C. for 4 hours. A solution containing 15% by mass polyimide with an imidation ratio of about 60% (this will be referred to as a polymer (PI-1)) was obtained by substituting the solvent in the system with new NMP after the dewatering cyclization reaction.

### <Preparation of Liquid Crystal Alignment Agent>

### Preparation Example 1

N-methyl-2-pyrrolidone (NMP) and butylcellosolve (BC) were added as organic solvents to the solution containing the polymer (PA-1), and a solution with a solvent composition of NMP/BC=42/58 (mass ratio) and solid content of 3.5% by mass was obtained. A liquid crystal alignment agent (AL-1) was prepared by filtering the solution with a filter with a pore size of 1 μm.

### Preparation Example 2

A liquid crystal alignment agent (AL-2) was prepared similarly to Preparation Example 1 other than that the used polymer was changed to the polymer (PI-1),

### Preparation Example 3

A photopolymerizable compound represented by Formula (L1-1) below was added to the solution containing the polymer (PA-1), N-methyl-2-pyrrolidone (NMP) and butylcellosolve (BC) were added as organic solvents to the solution containing the polymer (PA-1), and a solution with a solvent composition of NMP/BC=42/58 (mass ratio), a content ratio of the photopolymerizable compound of 30% by mass, and solid content of 3.5% by mass was obtained. A liquid crystal alignment agent (AL-3) was prepared by filtering the solution with a filter with a pore size of 1 μm.

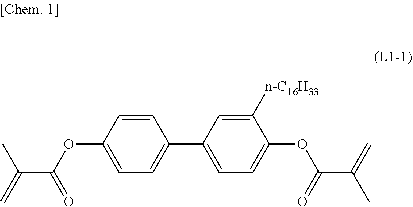

### <Preparation of Liquid Crystal Composition>

A liquid crystal composition LC1 was obtained by adding 0.3% by mass of the photopolymerizable compound represented by Formula (L1-1) described above to 10 g of nematic liquid crystal (manufactured by Merck KGaA; MLC-6608) with negative dielectric anisotropy and mixing them.

### <Manufacture and Evaluation of Liquid Crystal Element>

### Example 1

### (1) Manufacture of PSA Mode Liquid Crystal Display Device

A pair of substrates that had conductive films made of ITO electrodes on the respective surfaces of two glass substrates were prepared. The columnar spacers illustrated in FIG. 1 were formed on the electrode formation surface of one of the pair of substrates by the photolithography method. Then, the substrate surfaces of the pair of substrates were cleaned with ultrapure water. Next, the liquid crystal alignment agent (AL-1) prepared as described above was applied to the electrode surface of the substrate with no photospacers using a spinner. After the substrate to which the alignment agent was applied (referred to as a “substrate A”) was heated (pre-baked) on a hot plate at 80° C. for 2 minutes to remove the solvent, the substrate was heated (post-baked) in an oven substituted with nitrogen at 200° C. for 30 minutes, thereby forming a coated film with an average film thickness of 0.08 μm. Through these operations, a pair of substrates including the substrate A with the liquid crystal alignment film and the substrate B with no liquid crystal alignment film were obtained. Note that the electrode pattern used was the same as the electrode pattern in the PSA mode.

Then, the substrate A with the liquid crystal alignment film was used as a TFT substrate, the substrate B with no liquid crystal alignment film was used as a facing substrate, among the aforementioned pair of substrates, an epoxy resin adhesive containing aluminum oxide balls with a diameter of 3.5 μm was applied to an outer edge of the surface of the substrate A that had the liquid crystal alignment film, and the liquid crystal composition LC1 was dropped onto the substrate A using an ODF device. Note that the distance D between adjacent liquid droplets of the dropped liquid crystal was about 3 mm, and this was an ordinary distance between dropping points of liquid droplets in ODF. Then, the substrate A and the substrate B were overlaid and press-bonded such that the alignment film formation surface of the substrate A and the conductive film formation surface of the substrate B faced each other, and the adhesive was hardened by performing annealing processing, thereby producing a liquid crystal cell. Thereafter, AC 10 V at a frequency of 60 Hz was applied between the conductive films of the liquid crystal cell, and the liquid crystal cell was irradiated with ultraviolet rays with the irradiation amount of 5,000 J/m² using an ultraviolet irradiation device using a metal halide lamp as a light source in a state in which the liquid crystal was driven. Note that the irradiation amount was a value measured using an actinometer that performed measurement based on the wavelength of 365 nm.

### (2) Evaluation of Liquid Crystal Alignment Properties

Presence of abnormal domains in a change in brightness and darkness when the voltage of 5V applied to the liquid crystal display device obtained in (1) described above was turned ON and OFF (applied and released) was visually observed. At this time, vertical alignment properties in a case in which no light leakage was obtained when the voltage was turned OFF, white display was observed in a drive region when the voltage was applied, and no leakage was observed from the other region was evaluated as “excellent (⊚)”, vertical alignment properties in a case in which light leakage was slightly observed were evaluated as “good (∘)”, and vertical alignment properties in a case in which light leakage was clearly observed were evaluated as “allowable (Δ)”. As a result, the liquid crystal alignment properties in this example was evaluated as “Excellent (⊚)”.

### (3) Measurement of Pretilt Angles

Each of the pretilt angles of the substrate A and the substrate B in the liquid crystal display device obtained in (1) described above was measured. For the measurement of the pretilt angles, values of inclination angles relative to the substrate surface of the liquid crystal molecules were measured by a crystal rotation method using He—Ne laser light on the basis of the method disclosed in Non-Patent Document “T. J. Scheffer et. Al. J. Appl. Phys. Vo. 19, p. 2013 (1980)”, and these values were regarded as pretilt angles [°]. As a result, the pretilt angle of the substrate A was 84.9°, and the pretilt angle of the substrate B was 89.0°. Also, the tilt difference between the substrate A and the substrate B was 4.1°.

### (4) Measurement of PSA Peeling (Torsion)

As evaluation of peeling durability of the PSA layer in the liquid crystal display device obtained in (1) described above, alignment failures after application of external stress were measured. Specifically, a bar-shaped indenter with a diameter of 5 mm was pressed against it under a weight of 2.0 Kgf and a rotation speed of 200 rpm for 10 minutes, and the number of alignment failure locations where light absence in pixel under cross-nicol was then counted. A case in which the number of alignment failures was 0 was evaluated as “excellent (⊚)”, a case in which the number was 1 or 2 was evaluated as “good (∘)”, the case in which the number was equal to or greater than 3 was evaluated as “allowable (Δ)”, and the result in this example was “good (∘)”.

### (5) Measurement of Voltage Retention Ratio (VHR)

1 V of voltage was applied to the liquid crystal display device obtained in (1) described above at 70° C. for an application time of 60 microseconds at a span of 16.67 milliseconds, and VHR at 16.67 milliseconds after release of the application was then measured. The result in this example was 99%. Note that “VHR-1” manufactured by Toyo Corporation was used as a measurement device.

### (6) Evaluation of ODF Irregularity

2.5 V of AC voltage at 60 Hz was applied to the liquid crystal display device obtained in (1) described above, and irregularity (ODF irregularity) occurring in the entire liquid crystal display device was observed. A case in which no irregularity occurred was evaluated as “excellent (⊚)”, a case in which slight irregularity was visually recognized in at least any of the liquid crystal dropping positions and the intermediate portions of the liquid crystal dropping positions was evaluated as “good (∘)”, a case in which large irregularity was visually recognized in at least any of the liquid crystal dropping positions and the intermediate portions of the liquid crystal dropping positions was evaluated as “not good (Δ)”, and the result in this example was “good (∘)”.

### Examples 2 and 7

PSA mode liquid crystal display devices were manufactured similarly to Example 1 other than that liquid crystal alignment agents used were changed as described in Table 1 below, and evaluation of liquid crystal alignment properties, measurement of pretilt angles, measurement of PSA peeling, and measurement of VHR were performed. The measurement results are illustrated in Table 2 below. Note that in Table 1, “facing PS” represents that photospacers are included on the facing substrate and no photospacers are included on the TFT substrate (corresponding to FIG. 1).

### Example 3

A pair of substrates that had conductive films made of ITO electrodes on the respective surfaces of two glass substrates were prepared. Spacers (a first spacer 15a and a second spacer 15b) with a structure (described as an “irregular structure” in Table 1 below) illustrated in FIG. 3 were formed on the respective electrode formation surfaces of one substrate (TFT substrate) and the other substrate (facing substrate) of the pair of substrates by the photolithography method. The spacers were formed at arrangement in which the position of the second spacer 15b on the TFT substrate conformed to the position of the first spacer 15a on the facing substrate when the two substrates were attached to each other. A PSA mode liquid crystal display device was manufactured similarly to Example 1 other than that this pair of substrates were used, 3% by mass of aqueous solution of alkyl trimethyl ammonium bromide (alkyl chain having 5 carbon atoms) that was an anionic surfactant was used instead of ultrapure water to clean the substrate B, and evaluation of liquid crystal alignment properties, measurement of pretilt angles, measurement of PSA peeling, and measurement of VHR were performed. The measurement results are illustrated in Table 2 below. Also, when a PSA mode liquid crystal display device was manufactured in a manner similar to that described above other than that the cell structure illustrated in FIG. 4 was employed instead of the cell structure illustrated in FIG. 3, various types of evaluation was conducted, similar results were obtained.

### Example 4

A PSA mode liquid crystal display device that had spacers with the structure illustrated in FIG. 3 was manufactured similarly to Example 3 other than that 1% by mass aqueous solution of dimethyloctadecyl [3-(trimethoxysilyl)propyl] ammonium chloride (alkyl chain having 18 carbon atoms) was used to clean the substrate B, and evaluation of liquid crystal alignment properties, measurement of pretilt angles, measurement of PSA peeling, and measurement of VHR were performed. The measurement results are illustrated in Table 2 below. Also, when a PSA mode liquid crystal display device was manufactured in a manner similar to that described above other than that the cell structure illustrated in FIG. 4 was employed as in Example 3, various types of evaluation was conducted, similar results were obtained.

### Example 5

A PSA mode liquid crystal display device that had spacers with the structure illustrated in FIG. 3 was manufactured similarly to Example 3 other than that an aqueous solution of polyoxyethylene lauryl ether (18 carbon atoms) that was a nonionic surfactant at a concentration of 0.05% by mass was used to clean the substrate B, and evaluation of liquid crystal alignment properties, measurement of pretilt angles, measurement of PSA peeling, and measurement of VHR were performed. The measurement results are illustrated in Table 2 below. Also, when a PSA mode liquid crystal display device was manufactured in a manner similar to that described above other than that the cell structure illustrated in FIG. 4 was employed as in Example 3, various types of evaluation was conducted, similar results were obtained.

### Example 6

A PSA mode liquid crystal display device that had spacers with the structure illustrated in FIG. 3 was manufactured similarly to Example 3 other than that an aqueous solution of methacrylic acid 3-(trihydroxylsilyl)propyl(silane coupling agent) at a concentration of 0.05% by mass was used to clean the substrate B, and evaluation of liquid crystal alignment properties, measurement of pretilt angles, measurement of PSA peeling, and measurement of VHR were performed. The measurement results are illustrated in Table 2 below. Also, when a PSA mode liquid crystal display device was manufactured in a manner similar to that described above other than that the cell structure illustrated in FIG. 4 was employed as in Example 3, various types of evaluation was conducted, similar results were obtained.

### Example 8

An SS-VA mode liquid crystal display device was manufactured by performing operations similar to those in Example 1 other than that the liquid crystal alignment agent used was changed to (AL-3) and the annealing processing was not performed, and evaluation of liquid crystal alignment properties, measurement of pretilt angles, measurement of PSA peeling, and measurement of VHR were performed. The measurement results are illustrated in Table 2 below.

### Example 9

A liquid crystal display device was manufactured by performing operations similar to those in Example 1 other than that a liquid crystal composition LC1 was dropped onto the substrate A at equal intervals using an ink jet device (manufactured by Shibaura Mechatronics Corporation; IJ-6021) after applying an adhesive to an outer edge of the substrate A, then overlaying and press-bonding the substrate A and the substrate B such that the alignment film formation surface of the substrate A and the conductive film formation surface of the substrate B faced each other, and hardening the adhesive, and ODF irregularity was evaluated. The result in this example was “Excellent (⊚)”.

### Example 10

A liquid crystal display device was manufactured by performing operations similar to those in Example 1 other than that a liquid crystal composition LC1 was dropped onto the substrate A at equal intervals using an ODF device such that the distance between adjacent liquid droplets of the dropped liquid crystal was equal to or less than 0.5 mm after applying an adhesive to an outer edge of the substrate A, then overlaying and press-bonding the substrate A and the substrate B such that the alignment film formation surface of the substrate A and the conductive film formation surface of the substrate B faced each other, and hardening the adhesive, and ODF irregularity was evaluated. The result in this example was “Excellent (⊚)”.

### Example 11

A liquid crystal display device was manufactured similarly to Example 1 other than that a colored substrate obtained by the method disclosed in Example 7 of International Publication No. 2006/103908 was prepared as the substrate B and a liquid crystal alignment agent (AL-1) was applied thereto.

### Example 12

A liquid crystal display device was manufactured similarly to Example 1 other than that a colored substrate obtained by the method disclosed in Example 1 of Japanese Unexamined Patent Application Publication No. 2017-037299 was prepared as the substrate B and a liquid crystal alignment agent (AL-1) was applied thereto.

### Comparative Example 1

A PSA mode liquid crystal display device was manufactured similarly to Example 1 other than that the liquid crystal alignment agent (AL-1) was also applied to the substrate B similarly to the substrate A, and evaluation of liquid crystal alignment properties, measurement of pretilt angles, measurement of PSA peeling, and measurement of VHR were performed. The measurement results are illustrated in Table 2 below.

TABLE 1

| | Substrate cleaning | | | | | | | |
|---|---|---|---|---|---|---|---|---|
| | Cleaning | Temperature | Alkyl chain | Alignment | Substrate | Substrate | Spacer | |
| | solution | [w %] | length | agent | A | B | structure | Annealing |
| Example 1 | Ultrapure | — | — | AL-1 | Alignment | — | Facing side PS | Applied |
| | water | | | | agent applied | | | |
| Example 2 | Ultrapure | — | — | AL-2 | Alignment | — | Facing side PS | Applied |
| | water | | | | agent applied | | | |
| Example 3 | Anionic | 3 | 5 | AL-1 | Alignment | — | Irregular | Applied |
| | based | | | | agent applied | | | |
| Example 4 | Anionic | 1 | 18 | AL-1 | Alignment | — | Irregular | Applied |
| | based | | | | agent applied | | | |
| Example 5 | Nonionic | 0.05 | 18 | AL-1 | Alignment | — | Irregular | Applied |
| | based | | | | agent applied | | | |
| Example 6 | Silane | 0.05 | 3 | AL-1 | Alignment | — | Irregular | Applied |
| | coupling | | | | agent applied | | | |
| | agent | | | | | | | |
| Example 7 | Ultrapure | — | — | AL-3 | Alignment | — | Facing side PS | Applied |
| | water | | | | agent applied | | | |
| Example 8 | Ultrapure | — | — | AL-3 | Alignment | — | Facing side PS | Note applied |
| | water | | | | agent applied | | | |
| Example 9 | Ultrapure | — | — | AL-1 | Alignment | — | Facing side PS | Applied |
| | water | | | | agent applied | | | |
| | | | | | (ink jet) | | | |
| Example 10 | Ultrapure | — | — | AL-1 | Alignment | — | Facing side PS | Applied |
| | water | | | | agent applied | | | |
| | | | | | (ODF: | | | |
| | | | | | D ≤ 0.5) | | | |
| Example 11 | Ultrapure | — | — | AL-1 | Alignment | Colored layer | Facing side PS | Applied |
| | water | | | | agent applied | formed | | |
| Example 12 | Ultrapure | — | — | AL-1 | Alignment | Colored layer | Facing side PS | Applied |
| | water | | | | agent applied | formed | | |
| Comparative | Ultrapure | — | — | AL-1 | Alignment | Alignment | Facing side PS | Applied |
| Example 1 | water | | | | agent applied | agent applied | | |

TABLE 2

| | Example | Example | Example | Example | Example | Example | Example | Example | Comparative |
|---|---|---|---|---|---|---|---|---|---|
| | 1 | 2 | 3 | 4 | 5 | 6 | 7 | 8 | Example 1 |
| Substrate A | 84.9 | 85.3 | 84.5 | 84.5 | 84.5 | 84.5 | 84.5 | 84.5 | 84.9 |
| Tilt angle [°] | | | | | | | | | |
| Substrate B | 89.0 | 89.0 | 89.5 | 89.7 | 89.7 | 89.7 | 89.1 | 89.4 | 89.9 |
| Tilt angle [°] | | | | | | | | | |
| Tilt angle | 4.1 | 3.7 | 5 | 5.2 | 5.2 | 5.2 | 4.6 | 4.8 | 0.02 |
| difference | | | | | | | | | |
| between | | | | | | | | | |
| substrates A | | | | | | | | | |
| and B [°] | | | | | | | | | |
| PSA peeling | ◯ | ◯ | ⊚ | ⊚ | ⊚ | ⊚ | ◯ | ◯ | ◯ |
| VHR [%] | 99 | 99 | 99 | 99 | 99 | 99 | 99 | 99 | 99 |
| Alignment | ◯ | ◯ | Δ | ◯ | ⊚ | ⊚ | ◯ | ◯ | ◯ |
| properties | | | | | | | | | |

From the aforementioned results, it was confirmed that it was possible to cause a sufficient tilt difference between the substrates by forming the liquid crystal alignment film only on one of the pair of substrates. Further, it was confirmed that the tilt angle differences between the upper substrates and the lower substrates in the liquid crystal display devices (Examples 3 to 6) manufactured by combining the substrates cleaned with the aqueous solution of the water-soluble compound [B] and the substrates with the liquid crystal alignment films further increased and that the liquid crystal display devices exhibited high voltage retention ratios. The case in which the aqueous solution including the nonionic surfactant was used as the cleaning solution (Example 5) and the case in which the aqueous solution including the silane coupling agent was used (Example 6), in particular, were further preferable in terms of liquid crystal alignment properties. Also, it was confirmed that it was possible to preferably inhibit PSA peeling by using the pair of substrates with the spacer structures illustrated in FIGS. 3 and 4. Also, it was confirmed that it was possible to sufficiently inhibit ODF irregularity in the cases in which the ink jet device was used or the liquid crystal devices were manufactured using the ODF device such that the distance of the adjacent dropped liquid crystal was equal to or less than 0.5 mm (Examples 9 and 10). Further, it was possible to inhibit color degradation of the color filters in the liquid crystal display devices with the colored substrates formed on the substrates, on which the liquid crystal alignment films were not formed, on the pairs of the substrates (Examples 11 and 12) since it was not necessary to thermally harden the liquid crystal alignment films.

### <Evaluation of Afterimage (Burning Properties)>

Two liquid cells in each of Examples 3 to 6 and Comparative Example 1 were prepared, and external stress was applied to the liquid crystal cells similarly to “(4) Measurement of PSA peeling (torsion)”. Thereafter, the two liquid crystal cells were placed in an environment at 25° C. and 1 atm, and a synthesized voltage of 3.5 V of an AC voltage and 5V of a DC voltage was applied to one of them (the other was used for reference) for two hours. 4 V of an AC voltage was applied thereto immediately after then. Times until it became not possible to visually check differences in light transmittance from references after times at which 4 V of AC voltage was started to be applied were measured. A case in which the time was less than 50 seconds was evaluated as “excellent (⊚)”, afterimage properties in a case in which the time were equal to or greater than 50 seconds and less than 100 seconds was evaluated as “good (∘)”, afterimage properties in a case in which the time was equal to or greater than 100 seconds and less than 150 seconds were evaluated as “allowable (Δ)”, and afterimage properties in a case in which the time is greater than 150 seconds were evaluated as “not good (X)”. The result of evaluation in Comparative Example 1 was “not good” while the results of evaluation in Examples 3 to 6 were “good”.

Although the present disclosure has been described on the basis of embodiments, it is understood that the present disclosure is not limited to the above embodiments and structures. The present disclosure also includes modification made within the ranges of various modified examples and equivalent thereto. In addition, it is understood that not only various combinations and forms but also other combinations and forms further including only one element or more or less of the aforementioned combinations and forms come within the scope and the idea of the present disclosure.

### REFERENCE SIGNS LIST

10 Liquid crystal device
11 First substrate
12 Second substrate
13 Liquid crystal alignment film
14 Liquid crystal layer
15 Spacer
15a First spacer
15b Second spacer
20 Liquid crystal cell
31 Specific structure layer
32 Resin layer
33 Recess part

1. A liquid crystal device comprising:
a pair of substrates comprising a first substrate and a second substrate arranged to face each other; and
a liquid crystal layer that is arranged between the first substrate and the second substrate,
wherein a liquid crystal alignment film is formed on the first substrate, and the liquid crystal alignment film is not formed on the second substrate, among the first substrate and the second substrate.

2. The liquid crystal device according to claim 1, wherein the liquid crystal alignment film formed on the first substrate is an alignment film formed of a polymer composition containing a compound that has one or more polymerizable groups.

3. The liquid crystal device according to claim 1, wherein a layer comprising a water-soluble compound [B] that has at least one of a linear alkyl structure having three or more carbon atoms and an alicyclic structure is formed on the second substrate on a side of the liquid crystal layer.

4. The liquid crystal device according to claim 3, wherein the water-soluble compound [B] comprises a compound having at least one type of functional group selected from a group consisting of a vinyl group, an epoxy group, an amino group, a (meth)acryloyl group, a mercapto group, and an isocyanate group.

5. The liquid crystal device according to claim 1, wherein spacers extending in a direction toward the first substrate are formed on the second substrate.

6. The liquid crystal device according to claim 5, wherein a suppressing part mitigating misalignment of the liquid crystal layer caused by movement of a tip ends of the spacer is provided on the first substrate.

7. The liquid crystal device according to claim 6,
wherein the spacers are formed to be shorter or longer than a gap between the first substrate and the second substrate in a region in which the spacers are not arranged, and
the suppressing part is provided at a position, at which the suppressing part faces the spacers, on the first substrate and is in contact with the tip ends of the spacers.

8. The liquid crystal device according to claim 1, wherein the liquid crystal layer has negative dielectric anisotropy.

9. The liquid crystal device according to claim 1, wherein the liquid crystal layer is formed using a liquid crystal composition containing photopolymerizable monomers and has a polymer layer obtained by polymerizing the photopolymerizable monomers at a boundary part with respect to each of the pair of substrates.

10. The liquid crystal device according to claim 1, wherein the first substrate and the second substrate have a curved surface panel structure formed in a bent manner.

11. The liquid crystal device according to claim 1, wherein a colored layer containing at least one type selected from a group containing a quantum dot, a fluorescent substance, and a dye is formed on the second substrate.

12. A method of manufacture for a liquid crystal device comprising a pair of substrates comprising a first substrate and a second substrate arranged to face each other and a liquid crystal layer that is arranged between the first substrate and the second substrate, the method comprising:
forming a liquid crystal alignment film using a polymer composition on a surface of only the first substrate, among the first substrate and the second substrate;
constructing a liquid crystal cell by arranging the first substrate and the second substrate with a liquid crystal composition comprising a photopolymerizable monomer therebetween such that a film formation surface of the first substrate and a substrate surface of the second substrate face one another; and
irradiating the liquid crystal cell with light.

13. The method of manufacture for a liquid crystal device according to claim 12, wherein the polymer composition contains a compound that has one or more polymerizable groups.

14. The method of manufacture for a liquid crystal device according to claim 12, further comprising:
forming a layer comprising a water-soluble compound [B] that has at least one of a linear alkyl structure having three or more carbon atoms and an alicyclic structure on the second substrate.

15. The method of manufacture for a liquid crystal device according to claim 12, further comprising:
dropping the liquid crystal composition on one of the first substrate and the second substrate using an ink-jet application device.

16. The method of manufacture for a liquid crystal device according to claim 12, further comprising:
dropping the liquid crystal composition on one of the first substrate and the second substrate such that a distance between dropping points of liquid droplets is equal to or less than 3 mm using a liquid crystal dropping device.
